(19) United States
(12) Patent Application Publication
(10) Pub. No.: US 2011/0230332 A1
(43) Pub. Date: Sep. 22, 2011

(54) OLIGOMER/HALLOYSITE COMPOSITE MATERIAL AND METHOD FOR PREPARING THE SAME, AND HYDROCARBON ADSORBENT USING THE SAME

(75) Inventors: Kang-Sup CHUNG, Daejeon (KR); Yong-Jae SUH, Daejeon (KR); Dae-Sup KIL, Daejeon (KR); Hwan LEE, Daejeon (KR)

(73) Assignee: Korea Institute of Geoscience and Mineral Resources (KIGAM), Daejeon (KR)

(21) Appl. No.: 13/117,828

(22) Filed: May 27, 2011

Related U.S. Application Data
(62) Division of application No. 12/025,997, filed on Feb. 5, 2008.

(30) Foreign Application Priority Data
Nov. 19, 2007 (KR) 10-2007-0117787
Nov. 29, 2007 (KR) 10-2007-0122941

(51) Int. Cl. B01J 20/28; B82Y 30/00

(52) U.S. Cl. 502/62; 977/902; 977/762

(57) ABSTRACT

There is provided a method for manufacturing oligomer/halloysite composite material including the steps of: adding halloysite powder to an oligomer solution to be mixed; heating the mixed material to expand air inside of halloysite nanotube; and filling the oligomer solution inside of the halloysite nanotube by cooling the mixed material to a room temperature.

### CROSS-REFERENCES TO RELATED APPLICATIONS

The present invention claims priority of Korean Patent Application Nos. 10-2007-0117787 and 10-2007-0122941, filed on Nov. 19, 2007 and Nov. 29, 2007, and is a Divisional application of U.S. application Ser. No. 12/025,997 filed Feb. 5, 2008, respectively, which are incorporated herein by reference.

### BACKGROUND OF THE INVENTION

1. Field of the Invention

The present invention relates to an oligomer/halloysite composite material and a method for preparing the same, and a hydrocarbon adsorbent using the same; and, more particularly, to a composite material made by filling oligomer inside of a halloysite nanotube and a method for preparing the same, and an adsorbent using the composite material which can be applied to media capable of recovering by effectively adsorbing various organic compound including hydrocarbon or maximizing the continuity of effects thereof by gradually discharging the adsorbed functional materials.

The present invention is derived from a study performed as a part of a basic research project of MoST (Ministry of Science & Technology)[project management number: GP2007-007, title of project: DEVELOPMENT OF TECHNOLOGY FOR UTILIZING NATURAL NANOMINERALS; MANUFACTURING OF SMART NANOCONTAINER].

2. Description of Related Art

As the researches for materials having nano structures have been performed to various fields from every angle in recent, the endeavors for applying to various fields such as electro-optics field, fine chemistry field, medicine field, bio field or the like as adsorbent, catalyst, carrier, media or the like by using especially for nanoporous material are activated.

The materials having such pores are greatly classified according to the sizes of the pores into microporous having the size below 2 nm, mesoporous having the size of 2˜50 nm and macroporous having the size larger than 50 nm. Zeolite is most widely used as the microporous material and mesoporous silica is widely used as the mesoporous material which is a molecular sieve.

It is known that the mesoporous silica has a surface area of approximately 700 m²/g as a molecular sieve having a structure that pores of diameters of 1.5˜10 nm are generally arranged in regular, this is progressed to study as the nano material in catalyst, electro optics field, medicine field or the like. Generally, the mesoporous silica is chemically synthesized through hydrothermal reaction by using surfactant or amphiphilic polymer or the like through a liquid crystal templating mechanism.

Because the mesoporous material such as mesoporous silica has mesopores greater range than that of the microporous material, the applicability thereof has been increased by being applied to adsorption, separation, catalyst reactions of molecules having larger size than the micropores. And also, since such mesoporous material has the pores with the uniform size and has the very large surface area, it has the great applicability as media and can be widely utilized for conductive material, fine chemistry and bio fields, electro optics field or the like.

As the use of various agricultural chemicals and petroleum chemicals including herbicide is rapidly increasing in recent years, according to the increment of severity of environmental pollution accompanied by this, there has been actively progressed to the researches for media material capable of being used in adsorption of organic compound including hydrocarbon to minimize the pollution from this and for media material capable of controlling the elution speed of the functional material to improve the continuity of efficacy of the active chemical compound.

From the point of view, there have been published many research results for the mesoporous material as the nanoporous media to maximize the efficacy and continuity of the functional material such as functional cosmetics or special medicine as well as the adsorption of hydrocarbon.

But, the research results for such nanoporous material are not satisfied up to the present, there exists the requirements for the nanoporous material of high efficiency having excellent media characteristics capable of properly applied to various usages. And also, there exists the requirements for the absorbent having physical and chemical stabilities capable of adsorbing an organic material such as hydrocarbon with further excellent efficiency.

### SUMMARY OF THE INVENTION

An embodiment of the present invention is directed to providing an oligomer/halloysite composite material manufactured by filling oligomer inside of a holloysite nanotube and a method for preparing the same.

Another embodiment of the present invention is directed to providing a new functional hydrocarbon absorbent using oligomer/halloysite composite material manufactured by filling oligomer which represents excellent absorbing characteristics for hydrocarbon inside of a holloysite nanotube and a method for preparing the same.

In accordance with an aspect of the present invention, there is provided a method for manufacturing oligomer/halloysite composite material including the steps of: a) adding halloysite powder to an oligomer solution to be mixed; b) heating the mixed material to expand air inside of halloysite nanotube; and c) filling the oligomer solution inside of the halloysite nanotube by cooling the mixed material to a room temperature.

In accordance with another aspect of the present invention, there is provided an oligomer/halloysite composite which is made by filling oligomer inside of a halloysite nanotube.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### BRIEF DESCRIPTION OF THE DRAWINGS

FIGS. 1A and 1B are photographs taken by observing oligomer/halloysite composite material obtained in accordance with a second embodiment of the present invention with a FE-SEM (Field Emission Scanning Electron Microscope) (a) and a TEM (Transmission Electron Microscope) (b).

FIG. 2 is a graph obtained by analyzing the oligomer/halloysite composite material obtained in accordance with the second embodiment of the present invention with an X-ray diffractometer.

### DESCRIPTION OF SPECIFIC EMBODIMENTS

The advantages, features and aspects of the invention will become apparent from the following description of the embodiments with reference to the accompanying drawings, which is set forth hereinafter, accordingly those skilled in the art easily perform the technical spirit and scope of the present invention. And also, if the detailed description for a prior art related to the present invention unnecessarily makes the spirit and scope of the present invention unclear in explaining the present invention, the detailed description thereof will be omitted. Hereinafter, the detailed description of the present invention will be described in detail with reference to the accompanying drawings.

The oligomer/halloysite composite material in accordance with the present invention is formed by filling oligomer inside of a nanotube by using halloysite as a natural mineral having the nanotube structure.

The halloysite used in the present invention is an aluminum silicate clay mineral as the material represented by the following chemical formula 1

Al₂Si₂O₅(OH)₄2H₂O, [Chemical Formula 1]

wherein aluminum and silicon in the aluminum silicate clay mineral are in the ratio of 1:1. The halloysite has a nanotube structure having an empty inner space and an inner diameter ranging from 40 nm to 250 nm, so that it represents very excellent media characteristics in comparison with a conventional mesoporous silica chemically synthesized. Also, the halloysite has very excellent characteristics in utility as media since it is a natural mineral harmless to human beings and has no problems in environment pollution or human maleficence while being applied.

In the present invention, inside of pores of such halloysites, that is, the oligomer filled inside of the nanotube can be used for material without limitations if the material represents adsorption characteristics for an organic material such as hydrocarbon. The ordinary skilled person in the art can select and use the oligomer adapted to the adsorption of the organic material such as hydrocarbon among the known oligomer without any difficulties.

In particular, it is preferable that the oligomer is amphiphilic oligomer. That is, the amphiphilic oligomer has an advantage that it can be easily filled under a water-soluble condition using water as a solvent when the oligomer is filled inside of the halloysite since the amphiphilic oligomer represents hydrophilic property together. Such amphiphilic oligomer can be used by selecting an appropriate oligomer, and it can be used for material without limitations if the material represents adsorption characteristics for an organic material such as hydrocarbon, as described above.

For example, urethane acrylate oligomer can be used as the amphiphilic oligomer to be preferably used in the present invention. Such urethane acrylate oligomer has both hydrophobic and hydrophilic properties since it has a large hydrophilic propylene glycol functional group, and a manufacturing process can be easy since such hydrophilic property allows the oligomer to be filled into the halloysite under the water-soluble condition using the water as the solvent.

The urethane acrylate oligomer capable of being used in the present invention can be manufactured by mixing polypropylene glycol and isophorone diisocyanate to progress a urethane reaction, and then adding 2-hydroxy ethylacrylate and polyethylene glycol to the reacted mixture, but the present invention is not limited to this.

More particularly, the amphiphilic oligomer appropriately used in the present invention can be manufactured by a method which comprises the steps of i) mixing 50˜70 weight % of polyethylene glycol and 30˜50 weight % of isophorone diisocyanate to be reacted during 2˜4 hours at a temperature ranging from 50° C. to 100° C.; ii) adding 5˜25 weight % of 2-hydroxy ethylacryate with respect to a total weight of the mixed material to the mixed material of the step i) and reacting the mixed material with stirring 2˜4 hours at the same temperature; and iii) adding 25˜45 weight % of the polyethylene glycol with respect to the total weight of the reacted mixed material to the mixed material reacted at the step ii) at the same temperature after the reaction and stirring during 2˜4 hours.

It is preferable that the oligomer is used by being diluted at the degree of 4˜6 times using distilled water since the oligomer generally has a very high viscosity, in particular, it is preferable that a solution diluted by 5 times of distilled water is used.

In order to manufacture the composite material in accordance with the present invention, at first, the halloysite powder is added to the oligomer solution to be mixed. At this time, it is preferable that the composite material is manufactured by mixing 30˜50 weight % range of oligomer solution and 50˜70 weight % range of halloysite powder. And also, at the mixing step, it can be mixed by further adding the distilled water additionally.

In the next step, the air inside of the halloysite nanotube is expanded by heating the mixture of oligomer solution and halloysite powder. It is preferable that the heating is performed at a temperature ranging from 50° C. to 100° C. during 10˜30 minutes, and more specifically, it is preferable that the heating is performed at the temperature of 70° C. during approximately 20 minutes. An empty space can be formed by discharging a portion of air to outside of the nanotube since the air inside of the nanotube of the halloysite is expanded due to the heating.

As described above, if the heated mixture is gradually cooled to the room temperature again, the oligomer solution is filled into the empty space inside of the nanotube with condensing the expanded air inside of the halloysite nanotube. In order to sufficiently fill the oligomer into the halloysite nanotube, after the heated mixture is cooled to the room temperature, the heated mixture is stirred during 5˜30 minutes, preferably during approximately 10 minutes.

If the filling of oligomer inside of the halloysite nanotube is finished, it is preferable that filtering and drying processes are performed according to the known method. The filtering and drying processes can be used by selecting an appropriate process among the known methods, but it is not limited. The drying process can be performed, for example at the temperature ranging from 50° C. to 100° C., preferably at the temperature of approximately 70° C. in the air.

The oligomer/halloysite composite material in accordance with the present invention is implemented by filling the oligomer representing strong adsorption force for an organic material, especially for a hydrocarbon, into the halloysite pores having excellent media characteristics as porous materials of nanotube type. Therefore, the oligomer/halloysite composite material in accordance with the present invention can be used as an adsorbent having an adsorption performance with high efficiency for the organic material including the hydrocarbon, and also, can be usefully utilized as nanoporous media capable of maximizing the continuity of the effect by gradually discharging the adsorbed hydrocarbon.

Hereinafter, the present invention will be described in detail in accordance with the embodiments.

However, only the following embodiments exemplify the present invention, but the contents of the present invention is not limited to the following embodiments.

### Embodiment 1

### Manufacturing of Oligomer

In order to obtain the oligomer, 195.21 g of polypropylene glycol [GP1000] is mixed with 130.19 g of isophorone diisocyanate. After an urethane reaction is performed for the mixture at a temperature ranging from 55° C. to 60° C. during 2 hours, the temperature of the mixture maintains with 65° C. and the mixture is reacted by stirring during 3 hours.

At the temperature, the mixture is reacted by further adding 45.34 g of the 2-hydroxy ethylacryate[2-HEA] and stirring the mixture during 2 hours. Again, the urethane/acrylate oligomer is synthesized by adding 128.84 g of polyethylene glycol and 0.02 g of lauryl trimethyl tin as catalyst and by continuing the reaction with stirring during 3 hours.

### Embodiment 2

### Manufacturing Oligomer/Halloysite Composite Material (1)

The oligomer manufactured in the embodiment 1 is diluted to 1:5 by distilled water. In order to fill the oligomer into the halloysite, it is mixed in the weight ratio of halloysite:oligomer solution:distilled water as 1:1:5. After the air existing in the halloysite pores is heated and expanded by heating the mixture at the temperature of 70° C. during approximately 20 minutes, the oligomer solution is condensed and entered into the halloysite by continuously stirring during approximately 10 minutes with gradually cooling to the room temperature. If the filling of the oligomer into the halloysite nanotube is finished, after the filtering, the oligomer/halloysite composite material is manufactured by drying in the air at the temperature of 70° C.

### Embodiment 3

### Manufacturing Oligomer/Halloysite Composite Material (2)

The oligomer manufactured in the embodiment 1 is diluted to 1:5 by distilled water. In order to fill the oligomer into the halloysite, it is mixed in the weight ratio of halloysite:oligomer solution:distilled water as 1:2:5. After the air existing in the halloysite pores is heated and expanded by heating the mixture at the temperature of 70° C. during approximately 20 minutes, the oligomer solution is condensed and entered into the halloysite by continuously stirring during approximately 10 minutes with gradually cooling to the room temperature. If the filling of the oligomer into the halloysite nanotube is finished, after the filtering, the oligomer/halloysite composite material is manufactured by drying in the air at the temperature of 70° C.

### Embodiment 4

### Manufacturing Oligomer/Halloysite Composite Material (3)

The oligomer manufactured in the embodiment 1 is diluted to 1:5 by distilled water. In order to fill the oligomer into the halloysite, it is mixed in the weight ratio of halloysite:oligomer solution:distilled water as 1:2:1. After the air existing in the halloysite pores is heated and expanded by heating the mixture at the temperature of 70° C. during approximately 20 minutes, the oligomer solution is condensed and entered into the halloysite by continuously stirring during approximately 10 minutes with gradually cooling to the room temperature. If the filling of the oligomer into the halloysite nanotube is finished, after the filtering, the oligomer/halloysite composite material is manufactured by drying in the air at the temperature of 70° C.

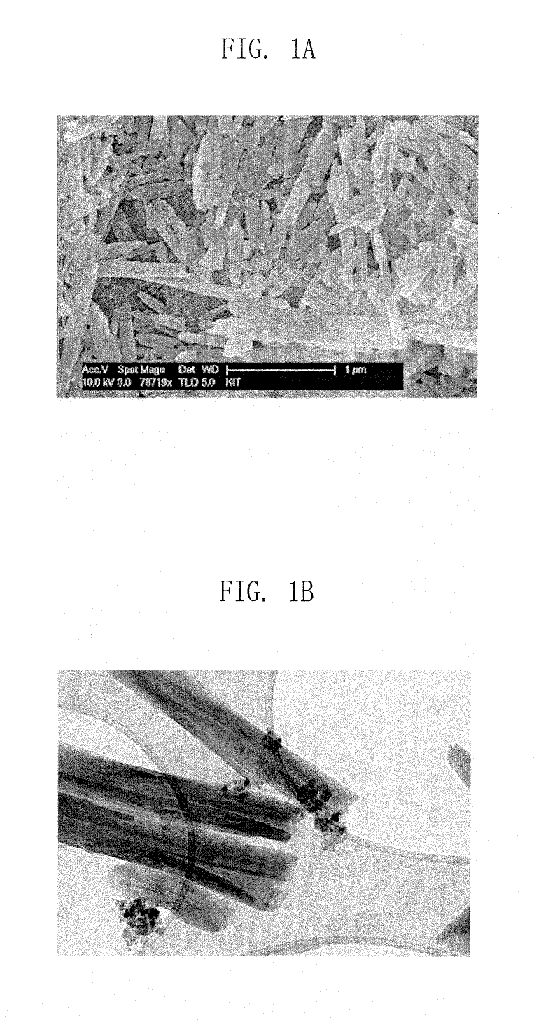

In FIGS. 1A and 1B, photographs taken by observing oligomer/halloysite composite material manufactured in accordance with the second embodiment of the present invention with a FM-SEM (Field Emission Scanning Electron Microscope) (a) and a TEM (Transmission Electron Microscope) (b) are represented, respectively. From FIGS. 1A and 1B, it is confirmed that the oligomer/halloysite composite material in accordance with the present invention forms the composite by filling the oligomer inside of the halloysite having the nanotube structure.

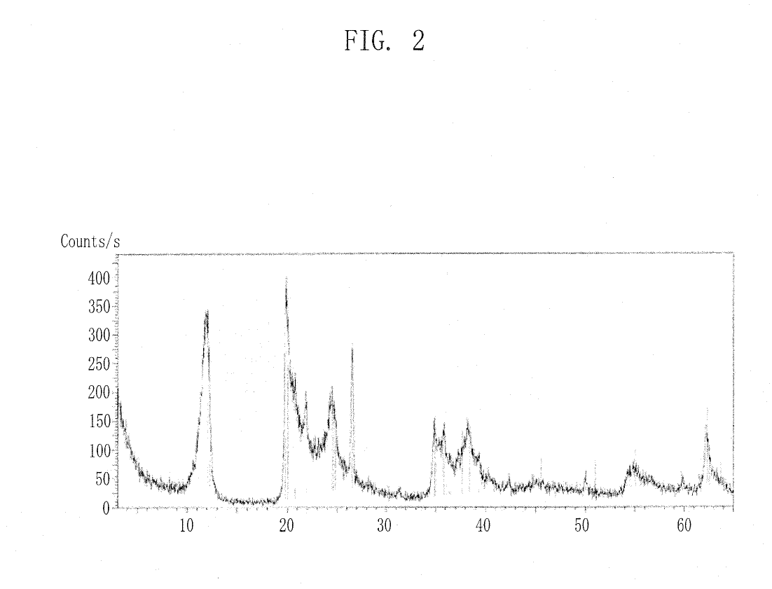

And also, the graph obtained by analyzing the oligomer/halloysite composite material obtained in accordance with the second embodiment of the present invention with an X-ray diffractometer is represented in FIG. 2. From the results, it is clearly identified that the oligomer/halloysite in accordance with the present invention is the composite material formed by filling the oligomer inside of the halloysite having the nanotube structure.

Since the oligomer/halloysite composite material manufactured by the above method in accordance with the present invention utilizes the halloysite of nanotube structure having excellent media characteristics, it does not cause the problem of an environmental pollution or harmfulness to human being. And also, since the oligomer having high adsorption capability for the hydrocarbon is utilized, the oligomer/halloysite composite material manufactured in accordance with the present invention can be utilized as a selective adsorbent of high efficiency. Therefore, coping with the recent interest of environmental pollution and health to the full, the present invention can be very usefully applied as an absorbent having high efficiency and selectivity, physical and chemical stabilities and durability with minimizing the pollutions.

And also, the composite material in accordance with the present invention can be widely applied to various fields as an excellent nanoporous media capable of improving the continuity of the benefits by controlling the elution speed of the adsorbed functional materials.

And also, while the present invention has been described with respect to certain preferred embodiments, it will be apparent to those skilled in the art that various changes and modifications may be made without departing from the scope of the invention as defined in the following claims.

The oligomer/halloysite composite material in accordance with the present invention can be used as an adsorbent having an adsorption capability for hydrocarbon of high efficiency by filling the oligomer representing high adsorption capability for the organic material including the hydrocarbon into the pores, i.e., inside of the nanotube, of halloysite having a nanotube structure.

And also, the composite material in accordance with the present invention can be applied as media capable of maximizing the continuity of benefit by gradually discharging the adsorbed hydrocarbon without causing the problems for the environment or health by using the halloysite excellent in media capability.

That is, since the composite material in accordance with the present invention is capable of being used as environment-friendly hydrocarbon adsorbent and media, it can be utilized as high efficient media capable of minimizing environmental pollution caused by a rapid increase in the use of various agricultural chemicals and petroleum chemicals including herbicide in recent years and capable of controlling the elution speed of the functional material to improve the continuity of efficacy of the functional material.

Further, the present invention can be utilized as the nanoporous media to maximize the efficacy and continuity of the functional materials such as functional cosmetics or special medicines by using such characteristics.

While the present invention has been described with respect to the specific embodiments, it will be apparent to those skilled in the art that various changes and modifications may be made without departing from the spirit and scope of the invention as defined in the following claims.

What is claimed is:

1. An oligomer/halloysite composite which is made by filling oligomer inside of a halloysite nanotube.

2. The oligomer/halloysite composite of claim 1, wherein the oligomer is amphiphilic oligomer.

3. The oligomer/halloysite composite of claim 2, wherein the amphiphilic oligomer is urethane acrylate oligomer.

4. A hydrocarbon adsorbent comprising oligomer/halloysite composite in accordance with claim 1.

5. A hydrocarbon adsorbent comprising oligomer/halloysite composite in accordance with claim 2.

6. A hydrocarbon adsorbent comprising oligomer/halloysite composite in accordance with claim 3.
